(19) United States
(12) Patent Application Publication
(10) Pub. No.: US 2024/0409249 A1
(43) Pub. Date: Dec. 12, 2024

(54) DEPLOYMENT SYSTEM FOR UNMANNED AERIAL VEHICLES

(71) Applicant: RapidFlight Holdings, Inc., Manassas, VA (US)

(72) Inventors: Jean-Charles Lede, Oakton, VA (US); Burak Uzman, Kensington, MD (US)

(21) Appl. No.: 18/208,772

(22) Filed: Jun. 12, 2023

Related U.S. Application Data
(63) Continuation of application No. 18/204,605, filed on Jun. 1, 2023.

(51) Int. Cl. B64U 70/50; B64U 80/10; B64U 80/70

(52) U.S. Cl. CPC B64U 70/50; B64U 80/10; B64U 80/70; B64C 3/56; B64U 50/37

(57) ABSTRACT

A deployment system for unmanned aerial vehicles (UAV) includes a container, at least one storage rack disposed within the container, and a launcher. The at least one storage rack is configured to store a plurality of UAVs and to selectively dispense the UAVs. The launcher includes at least one engagement member configured to engage any UAV of the plurality of UAVs, and a conveyor operable to accelerate the engaged UAV from an engagement position to a release speed. The deployment system also includes a UAV handler configured to receive each UAV of the plurality of UAVs from the at least one storage rack and transfer the UAV to the launcher.

### CROSS REFERENCE TO RELATED APPLICATIONS

This application is a continuation of, and claims priority to, U.S. application Ser. No. 18/204,605, entitled “DEPLOYMENT SYSTEM FOR UNMANNED AERIAL VEHICLES,” filed Jun. 1, 2023, the contents of which are hereby incorporated by reference in their entirety.

### TECHNICAL FIELD

The present technology pertains to unmanned aerial vehicles, and more specifically, to a deployment system for unmanned aerial vehicles.

### BACKGROUND

Unmanned aerial vehicles (UAVs), sometimes referred to as “drones,” are increasingly being used for a wide range of applications. A range of the UAVs is typically limited by an amount of fuel or a size of a propulsive power source that the UAV can carry on-board. Moreover, adding to the amount of fuel or size of the propulsive power source tends to correspondingly reduce a weight of a useful payload that the UAV can carry. It can therefore be advantageous to set up a temporary UAV deployment site that is relatively close to an area where the payload of the UAV is desired to be used. However, setting up a temporary UAV deployment site is typically time consuming and requires relatively extensive human on-the-ground presence, and in the case of fixed-wing UAVs can require a relatively large and flat ground area to enable the UAVs to achieve flight.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure introduces a novel deployment system for UAVs that can be rapidly transported, transitioned to operational status, and requires only a small footprint even for fixed-wing UAVs.

In one aspect, a deployment system for unmanned aerial vehicles (UAV) is provided. The deployment system includes a container, at least one storage rack disposed within the container, and a launcher. The at least one storage rack is configured to store a plurality of UAVs and to selectively dispense the UAVs. The launcher includes at least one engagement member configured to engage any UAV of the plurality of UAVs, and a conveyor operable to accelerate the engaged UAV from an engagement position to a release speed. The deployment system also includes a UAV handler configured to receive each UAV of the plurality of UAVs from the at least one storage rack and transfer the UAV to the launcher.

In another aspect, a method of operating a deployment system is provided. The deployment system includes a container, at least one storage rack disposed within the container and configured to store and dispense a plurality of UAVs, a launcher, a UAV handler, and a controller in electronic communication with the at least one storage rack, the launcher, and the UAV handler. The controller includes at least one processor programmed to automatically perform steps of the method, including one or more of: operating the at least one storage rack to dispense a UAV of the plurality of UAVs to the UAV handler, operating the UAV handler to transfer the UAV to an engagement position relative to the launcher, causing at least one engagement member of the launcher to engage the UAV, and operating a conveyor of the launcher to accelerate the engaged UAV from the engagement position to a release speed.

In another aspect, a method of assembling a deployment system for a plurality of UAVs is provided. The method includes one or more of: coupling at least one storage rack to a container, wherein the at least one storage rack is configured to store and dispense the plurality of UAVs; coupling a launcher to the container, where the launcher includes at least one engagement member configured to engage the UAVs and a conveyor operable to accelerate the engaged UAV from an engagement position to a release speed; and coupling a UAV handler to the container, the UAV handler configured to receive a UAV dispensed from the at least one storage rack and deliver the UAV to the launcher.

### BRIEF DESCRIPTION OF THE SEVERAL VIEWS OF THE DRAWINGS

In order to describe the manner in which the above-recited issues can be addressed, a more particular description of the principles briefly described above will be rendered by reference to specific embodiments thereof that are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a cutaway perspective view of an example deployment system for unmanned aerial vehicles (UAVs) in accordance with one embodiment;

FIG. 2A illustrates a perspective view of an example UAV, in a folded configuration, that can be used with the deployment system of FIG. 1 in accordance with one embodiment.

FIG. 2B illustrates a perspective view of the example UAV of FIG. 2A, in a deployment configuration.

FIG. 3A illustrates a perspective view of an example cartridge for storing UAVs that can be used with the deployment system of FIG. 1 in accordance with one embodiment.

FIG. 3B illustrates a perspective view of an example internal structure of the cartridge of FIG. 3A in accordance with one embodiment.

FIG. 3C illustrates a perspective view of an example installation of cartridges in the deployment system of FIG. 1 in accordance with one embodiment.

FIG. 4A illustrates a side elevation view of an example container that can be used with the deployment system of FIG. 1 in accordance with one embodiment.

FIG. 4B illustrates an end elevation view of the example container of FIG. 4A in accordance with one embodiment.

FIG. 5 is a flow diagram of an example method of operating a deployment system for UAVs, such as the deployment system of FIG. 1.

FIG. 6 is a flow diagram of an example method of assembling a deployment system for UAVs, such as the deployment system of FIG. 1.

FIG. 7 illustrates a computer system that can be implemented with other aspects of the present disclosure.

### DETAILED DESCRIPTION

Various example embodiments of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment. Such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term).

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

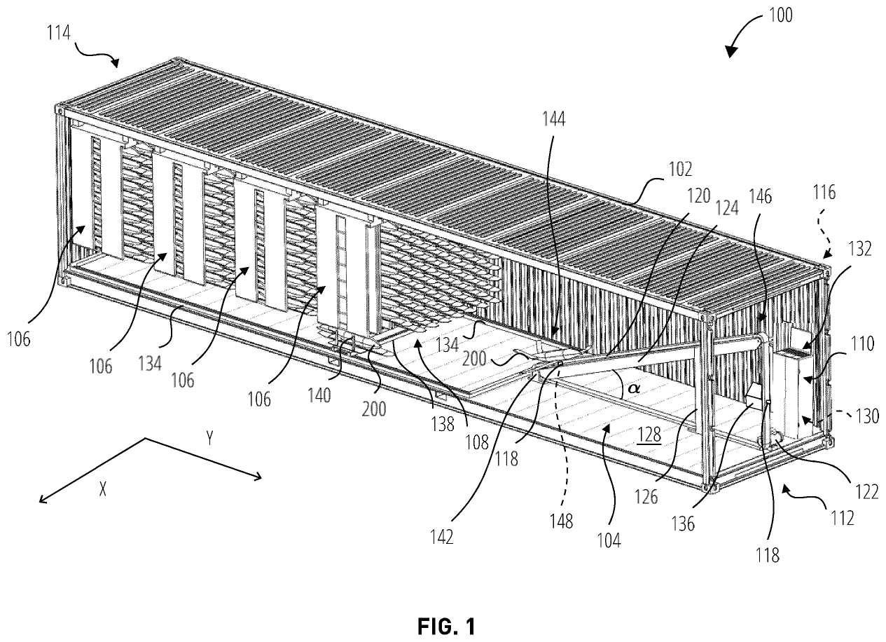

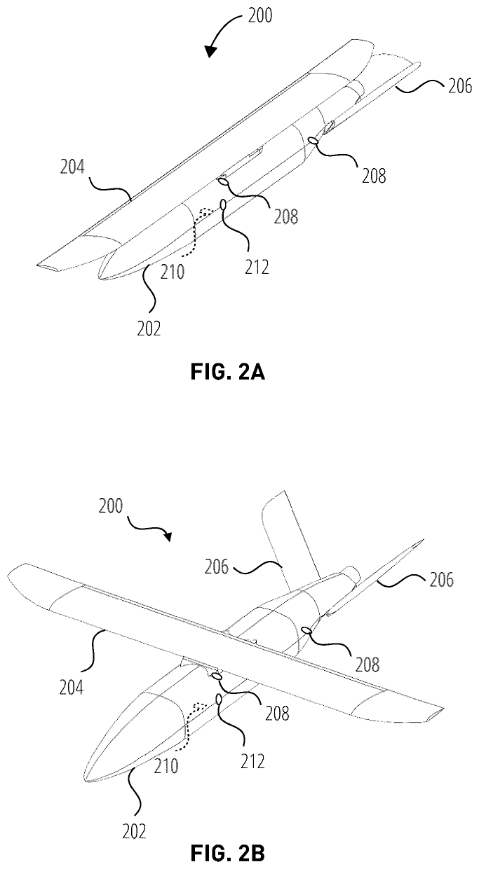

FIG. 1 illustrates a cutaway perspective view of an example embodiment of a deployment system 100 for unmanned aerial vehicles (UAVs) 200. FIG. 2A illustrates a perspective view of an example embodiment of one of the UAVs 200 200 in a folded configuration, and FIG. 2B illustrates a perspective view of the UAV 200 in a deployment configuration.

In the example embodiment, the deployment system 100 includes a container 102, at least one storage rack 106 disposed within the container and configured to store and dispense a plurality of UAVs 200, a launcher 104, and a UAV handler 108 configured to receive a UAV 200 of the plurality of UAVs from the at least one storage rack 106 and transfer the UAV to the launcher 104. The launcher 104 includes at least one engagement member 118 configured to engage the UAV 200, and a conveyor 120 operable to accelerate the engaged UAV from an engagement position to a release speed. The at least one engagement member 118 can be further configured to disengage from the engaged UAV 200 after the acceleration to the release speed. In FIG. 1, one of the UAVs 200 is illustrated in an example of the engagement position, at a first ramp end 144 of the launcher 104, and engaged by the engagement member 118. However, other locations for the engagement position relative to the launcher are also contemplated.

In particular, in the illustrated embodiment, the UAVs 200 are operable as powered fixed-wing UAVs. For example, each of the UAVs 200 can include one or more on-board power sources such as batteries, fuel cells, or internal combustion engines (not shown) coupled to propellers, jet nozzles, or the like. Moreover, different ones of the UAVs 200 in the at least one storage rack 106 can include different power sources. Powered fixed-wing aircraft such as UAVs 200 typically require a takeoff runway of a minimum length in order to achieve flight speed. The launcher 104 advantageously reduces the minimum takeoff length by imparting the release speed to the engaged UAV 200 over a relatively short ground area, independently of the on-board power source of the UAV.

The launcher 104 can include a conveyor motor 122 configured to drive the conveyor 120. For example, the conveyor motor 122 can be an electric motor. The deployment system 100 can include a power source 130 mounted inside the container 102, and the power source 130 can be configured to drive the conveyor motor 122. For example, the power source 130 can include one or more power sources such as batteries, fuel cells, or internal combustion engines. Additionally or alternatively, the deployment system 100 can be configured to receive power from an external source and to distribute the received power to the conveyor motor 122.

The conveyor 120 can be formed from a closed loop member, such as but not limited to a drive chain. After a first UAV 200 is launched, the closed-loop conveyor 120 can be rotated around to bring another engagement member 118 into position to engage a second UAV 200. For example, each engagement member 118 can include a pin that extends radially outward from, and is configured to move with, the closed loop member. Each UAV 200 can include an engagement interface 210 configured to cooperate with the engagement member 118. In some embodiments, the engagement interface 210 can include a recess shaped and oriented to receive and engage with the pin of the engagement member 118. For example, the UAV 200 can be positioned at the engagement position just above the conveyor 120, and the conveyor can be rotated until the pin of the at least one engagement member 118 comes around under the UAV 200 and engages with the recess of the engagement interface 210. Additionally or alternatively, other cooperating features are also contemplated for the at least one engagement member 118 and the engagement interface 210.

Although the launcher 104 includes two engagement members 118 in the illustrated embodiment, embodiments with one or more than two engagement members 118 are also contemplated. Including more than one engagement member 118 can advantageously reduce a time needed to re-position the conveyor 120 for engagement with another UAV 200 after a previous UAV 200 is launched.

In some implementations, the UAV 200 is at rest (i.e., zero velocity) when it is engaged by the engagement member 118. In other implementations, the UAV 200 can remain in motion throughout delivery to the launcher 104, engagement by the engagement member 118, and acceleration to the release speed. Maintaining the UAVs 200 in motion throughout delivery and launch can advantageously increase a number of UAVs 200 launched by the deployment system 100 per unit time.

Similarly, in some implementations, the conveyor 120 is decelerated to rest (i.e., zero velocity) after a first UAV 200 is launched to facilitate engagement of a next UAV 200 by the at least one engagement member 118. In other implementations, the conveyor 120 can remain in motion throughout acceleration of the first UAV 200 to the release speed, deceleration to a lower velocity that facilitates engagement of the next UAV 200 at the engagement position by the at least one engagement member 118, and acceleration of the next UAV 200 to the release speed. Maintaining the conveyor 120 in motion throughout engagement and launch of consecutive UAVs 200 can advantageously increase a number of UAVs 200 launched by the deployment system 100 per unit time.

In some embodiments, the launcher also includes a ramp 124 oriented at a launch angle α, and the conveyor is configured to travel along the ramp 124. For example, the launch angle can be selected to enable the launched UAV 200 to clear obstacles (for example, buildings, trees, or hills) located near the container 102. Additionally or alternatively, the launch angle can be selected to decrease a time required for the UAV 200 to achieve an optimal climbing lift profile or mission altitude. Although the illustrated launch angle α is about 30 degrees, other launch angles (including a horizontal or zero-degree launch angle, in which the UAV 200 gains altitude based solely on its own lift characteristics) are contemplated. The launcher can include at least one ramp support 126 configured to support the ramp 124 at the launch angle. In some embodiments, the at least one ramp support 126 is actuatable to adjust a value of the launch angle α on a per-launch basis based on one or more of the parameters discussed above.

The ramp 124 can extend from the first ramp end 144, located at or near the engagement position, to a second ramp end 146. The launcher 104 can be configured to accelerate the engaged UAV 200 to the release speed before the engaged UAV 200 passes the second ramp end 146. As the engaged UAV 200 passes the second ramp end 146, the momentum of the engaged UAV 200 causes the UAV to continue at the launch angle, while the engagement member 118 to which the engaged UAV was coupled rotates downward with the conveyor 120 past the second ramp end 146. In some embodiments, such as the pin-and-recess example described above, the engagement member 118 is configured to passively disengage from the engagement interface 210 as the engagement member rotates downward at the second ramp end 146 while the UAV continues forward at the launch angle. Such passive disengagement can advantageously reduce an operational and design complexity of the launcher 104. However, active disengagement or release mechanisms for the at least one engagement member 118 are also contemplated. For example, the engagement member 118 can be configured to retract down into the conveyor 120 as the engagement member 118 approaches the second ramp end 146, for example via a mechanical cam or control-actuated coupling (not shown).

In some embodiments, the launcher 104 is operable to accelerate and release the UAVs 200 from entirely within the container 102. For example, the launch angle α of the conveyor 120 can be oriented to release the UAV 200 within an interior of the container and launch the UAV 200 through an aperture created at the first end 112 of the container when one or more container doors 116 at that end are opened. This can advantageously reduce a footprint needed to operate the deployment system 100. Additionally or alternatively, the conveyor 120 can be deployable from a position entirely within the container 102 (for example, during transport and storage of the deployment system 100) to extend at least partially outside the container 102 (for example, during launch operations). For example, this can advantageously enable use of a larger launch angle α when a larger footprint for the deployed system is available.

For example, the launcher 104 can further include a launch platform 128 configured to support the conveyor 120, and the launch platform 128 can be configured to move the conveyor 120 from a storage position entirely within the container 102 (as illustrated in FIG. 1) to a launch position at least partially outside the container 102. In one implementation, the launch platform 128 is translatable relative to the container 102 between a first position (corresponding to the storage position of the conveyor 120), in which the launch platform 128 is completely within the container 102, to a second position (corresponding to the launch position of the conveyor 120), in which the launch platform 128 is at least partially outside the container 102. In some implementations, the launch platform 128 in the second position can be entirely outside the container 102. For example, the launch platform 128 and the conveyor 120 supported thereon can be moved through an aperture created at the first end 112 when the one or more container doors 116 at that end are opened. Other implementations for positioning or extending the conveyor to extend at least partially outside the container 102 are also contemplated.

The deployment system 100 can also include a controller 110 in electronic communication with the launcher 104 and one or more other components of the system, as will be described herein. The controller can include a local user interface 132 that enables an operator to assist with configuration or operation of the components of the deployment system 100. The controller can also include a communications interface 740 (shown in FIG. 7) that enables remote operator interaction with the controller and the components of the deployment system 100, for example via wireless communication. For example, but not by way of limitation, a remote operator can send commands to the controller that include mission parameters and instructions specifying a type of UAV 200 to be used for a mission.

The controller 110 can be programmed to automatically perform steps such as positioning the at least one engagement member 118 to engage the UAV 200 at the engagement position, and operating the conveyor 120 to accelerate the engaged UAV 200. As one example, the conveyor motor 122 can be a servo motor, and the controller 110 can be programmed to operate the servo motor to rotate the conveyor 120 until the at least one engagement member 118 is in position to engage the UAV, and then to accelerate the conveyor 120. For example, the launcher 104 can further include an engagement sensor 148 configured to output a signal indicating engagement of the UAV 200 by the engagement member 118. The controller 110 can be programmed to detect, based on a signal from the engagement sensor 148, that the engaged UAV is engaged, and to initiate the step of accelerating the engaged UAV to the release speed in response to the detecting. Other operational couplings of the controller 110 to the launcher 104 are also contemplated.

The controller 110 can also be programmed to advantageously control other operational aspects of the deployment system 100. For example, in embodiments in which the conveyor 120 is implemented as a closed loop member and the at least one engagement member 118 is configured to move with the closed loop member, the controller 110 can be programmed to position, after the engaged UAV 200 is accelerated to the release speed, the at least one engagement member 118 to enable engagement of a next UAV 200 of the plurality of UAVs 200, as discussed above, and to accelerate the engaged next UAV 200 from the engagement position to the release speed.

Similarly, the controller 110 can be in electronic communication with the at least one storage rack 106 and the UAV handler 108. The controller can be programmed to operate the at least one storage rack 106 to dispense the next UAV 200, and to operate the UAV handler 108 to receive the next UAV 200 from the at least one storage rack 106 and transfer the next UAV 200 to the launcher 104.

In some implementations, the use of the controller 110 to perform one or more of the steps above advantageously increases a speed at which the deployment system 100 can launch multiple UAVs 200. For example, rather than waiting for the at least one engagement member 118 to be in position for engagement before retrieving the next UAV, the step of operating the at least one storage rack 106 to dispense the next UAV 200 can be initiated before the step of positioning the at least one engagement member 118 to enable engagement of the next UAV 200 is completed. The precision and coordination of movement provided by the automatic controller 110 enables the timing of such steps to be optimized to reduce or eliminate lag time between the steps.

In certain embodiments, the container 102 is configured for mounting on a moving conveyance, such as a rail car, a cargo ship, a tractor-trailer, or another shipping conveyance. The controller 110 can be programmed to receive conveyance data indicating one or more of a location, a speed, an orientation, or a heading direction of the conveyance, and to operate the launcher 104 based on the received conveyance data. For example, the controller 110 can delay launch operations if one or more of the location, speed, orientation, heading direction, or another parameter are not conducive to successful launch of the UAVs 200. Additionally or alternatively, the controller 110 can adjust one or more of the release speed, the launch angle, and a launch timing to compensate for non-nominal values of one or more of the location, speed, orientation, heading direction, or another parameter. Similarly, the controller 110 can be programmed to receive obstruction data indicating a location of obstructions (such as tunnels, overpasses, buildings, trees, hills) in an environment near the conveyance, and to operate the launcher 104 based on the received obstruction data.

The UAV handler 108 can include one or more gantry rails 134 affixed to the container 102 and extending between the at least one storage rack 106 and the launcher 104. For example, in the illustrated embodiment, the container 102 has a footprint that extends, along a longitudinal direction Y, from a first end 112 to a second end 114. The launcher 104 is positioned adjacent to the first end 112, storage racks 106 in rows along a transverse direction X are positioned adjacent to the second end 114, and a pair of gantry rails 134 extend along a floor of the container 102 in the longitudinal direction from beneath the storage racks 106 to the launcher 104. However, other arrangements of the at least one gantry rail 134 between the at least one storage rack 106 and the launcher 104 are also contemplated.

The UAV handler 108 can also include a cradle 140 coupled for movement along the one or more gantry rails 134. The cradle 140 is configured to receive the UAV 200 from any one of the storage racks 106. For example, the cradle 140 can be positionable along the gantry rails 134 at multiple locations along the longitudinal direction Y under the storage racks 106. The UAV handler 108 can also be configured to receive the UAV 200 from the at least one storage rack 106 at multiple locations distributed transversely to the longitudinal direction Y. For example, the UAV handler 108 can further include one or more transverse rails 138 oriented transverse to, and coupled for movement along, the one or more gantry rails 134, and the cradle 140 can be coupled for movement along the one or more transverse rails 138 along the transverse direction. In some implementations, the one or more transverse rails 138 are coupled to the gantry rails 134 by a first carriage (not visible in the figures) that rolls or slides along the one or more gantry rails 134, and the cradle 140 is coupled to the one or more transverse rails 138 by a second carriage (not visible in the figures) that rolls or slides along the one or more gantry rails 134. Although the transverse direction X is illustrated as orthogonal to the longitudinal direction Y, non-orthogonal orientations of the transverse direction are also contemplated.

Although only one launcher 104 is illustrated, in some embodiments the deployment system 100 further includes a second launcher 104 configured in similar fashion to the first launcher 104. For example, the at least one storage rack 106 can be located in a mid-portion (relative to the longitudinal direction Y) of the container 102, and the second launcher 104 can be positioned to launch UAVs 200 through the second end 114 of the container. The UAV handler 108 can be further configured to transfer any UAV 200 received from the at least one storage rack 106 selectively to either the first or the second launcher 104. The inclusion of two launchers 104 can advantageously increase a speed at which the deployment system 100 can launch multiple UAVs 200. For example, the conveyor 120 of the first launcher 104 can be operable to accelerate a first UAV 200 from the engagement position to the release speed and the conveyor 120 of the second launcher 104 can be operable to accelerate a second UAV 200 from the engagement position to the release speed during an at least partially overlapping time interval.

In some embodiments, each of the plurality of UAVs 200 includes a primary lift surface 204, and the at least one storage rack 106 is configured to store the UAVs having the primary lift surface 204 in a folded configuration. A non-limiting example of the folded configuration is shown in FIG. 2A. The folded configuration can significantly increase a number of UAVs 200 that can be stored and transported within a given volume of the container 102. The UAV handler 108 can include an automated end effector 142 operable to interact with the UAV 200 to transition the primary lift surface 204 from the folded configuration to a flight configuration. A non-limiting example of the flight configuration is shown in FIG. 2B.

The example UAV 200 illustrated in FIG. 2A and FIG. 2B includes a primary lift surface 204, which functions as a fixed wing extending transversely from both sides of the fuselage 202 of the UAV in the flight configuration, and two secondary lift surfaces 206, which function together as a v-tail in the flight configuration. However, this arrangement of lift surfaces is for example only and any other suitable configuration of lift surfaces is contemplated. In the folded configuration, the primary lift surface 204 is rotated 90 degrees in-plane to align its span with the fuselage 202 of the UAV, and the two secondary lift surfaces 206 are rotated about 90 degrees downward and rearward to align their spans with the fuselage 202 of the UAV. Accordingly, the folded configuration significantly reduces a longitudinal cross-sectional profile of the UAV 200 and enables the UAVs 200 to be tightly packed in the at least one storage rack 106. However, this folding arrangement of the lift surfaces is for example only and any other suitable folding arrangement is contemplated.

Each foldable UAV 200 can include an end effector interface 208 designed for cooperation with the end effector 142 to cause deployment of the folded primary lift surfaces. The end effector 142 and end effector interface 208 can be configured to cooperate in various ways in different embodiments. For example, the UAV 200 can include a pre-coiled spring-loaded mechanism coupled to the lift surfaces that biases the lift surfaces towards the flight configuration, and the end effector interface 208 can be a pin that holds the spring in the loaded position. The end effector 142 can be configured to pull the pin to cause the lift surfaces to spring to the flight configuration. For another example, the UAV 200 can include an electromechanical actuator such as a solenoid or a servomotor coupled to the lift surfaces that biases the lift surfaces towards the flight configuration, and the end effector interface 208 can be a push-button or switch that triggers the actuator. The end effector 142 can be configured to push the button or flip the switch to cause the lift surfaces to actuate to the flight configuration. Other implementations for cooperation between the end effector 142 and the end effector interface 208 are also contemplated. In any of these implementations, the UAV 200 can also include a locking mechanism (not shown) to lock the lift surfaces in place once they have moved to the flight configuration.

In other embodiments, the end effector 142 may be configured to move one or more of the lift surfaces from the stored configuration to the flight configuration by physically bearing against the lift surface to move the lift surface with respect to fuselage 202. In other words, the end effector 142 may simply push the lift surface into the flight configuration. The end effector interface 208 may simply be a location on the lift surface configured to receive contact from the end effector 142.

In the illustrated embodiment, the end effector 142 is mounted to the launch platform 128 adjacent to the engagement position, so that, for example, the end effector 142 can interact with the UAV 200 just before the UAV 200 is delivered to the first ramp end 144, while the UAV 200 is positioned above the first ramp end 144 waiting for engagement, or after the UAV 200 is engaged by, the engagement member 118. However, it is contemplated that the end effector 142 can be mounted in other locations, for example on the cradle 140 or on a floor of the container 102 adjacent to the launch platform 128.

In other embodiments, rather than or in addition to use of the end effector 142, the UAV 200 itself may be configured to move one or more of the lift surfaces from the stored configuration to the flight configuration in response to an electronic command. For example, the controller 110 can be programmed to send an electronic command to the UAV 200, and the electronic command can cause the UAV 200 to automatically transition the lift surface from the folded configuration to the flight configuration.

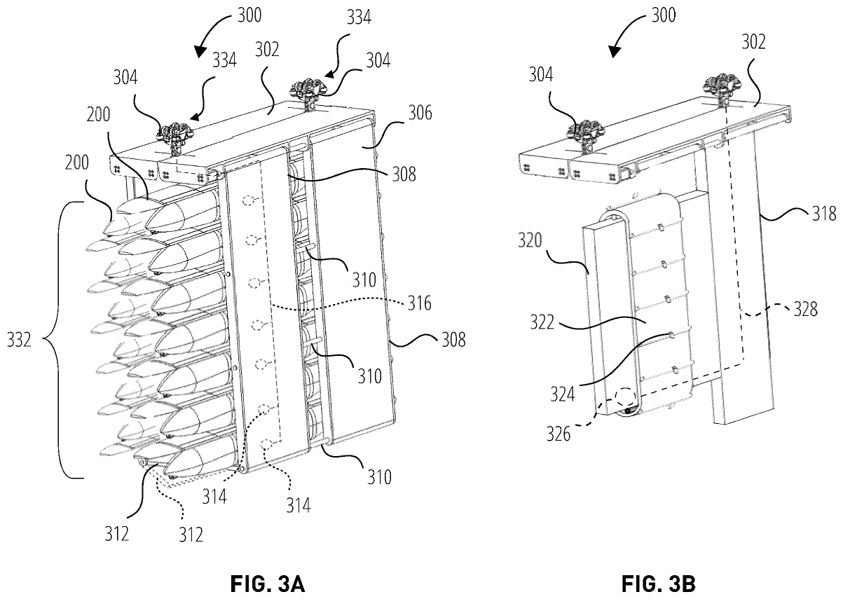

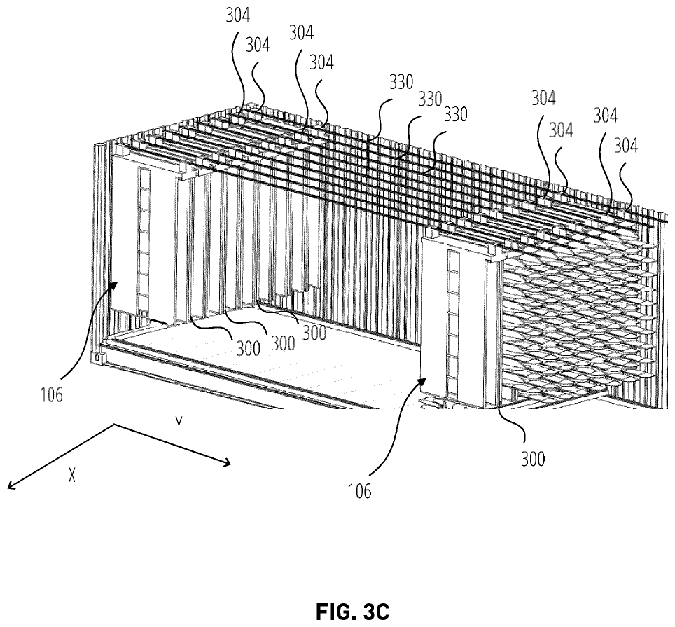

FIG. 3A illustrates a perspective view of an example embodiment of a cartridge 300 that can be used as part of the at least one storage rack 106. FIG. 3B illustrates a perspective view of an example embodiment of an internal structure of the cartridge 300, and FIG. 3C illustrates a perspective view of an example installation of the cartridges 300 in the container 102. The at least one storage rack 106 can include one or more of the cartridges 300 each configured to store and dispense a subset 332 of the plurality of UAVs 200. The cartridge 300 can be configured to sequentially position each UAV 200 of the subset 332 for dispensing to the UAV handler 108. In other words, the cartridge 300 can be configured to dispense the UAVs in one-at-a-time fashion. Other dispensing configurations are also contemplated.

Each cartridge 300 can be configured to store UAVs 200 of a different shape or size. In other words, the one or more cartridges can include a first cartridge 300 configured to store and dispense a first type of UAV, and a second cartridge 300 configured to store and dispense a second type of UAV.

In some embodiments, the deployment system 100 also includes at least one cartridge rod 330 affixed to and extending within the container 102, and the one or more cartridges 300 is coupled to the at least one cartridge rod 330. In the illustrated embodiment, the at least one cartridge rod 330 includes a plurality of cartridge rods 330 extending in the longitudinal direction Y adjacent to the ceiling of the container 102. However, other numbers and arrangements of the cartridge rods 330 are also contemplated. In some implementations, one cartridge rod 330 can be configured to support multiple cartridges 300. For example, FIG. 3C illustrates how a first cartridge 300 and a second cartridge 300 can be slidingly coupled in succession onto each cartridge rod 330. Moreover, the cartridges 300 can be interchangeably coupled to the cartridge rods 330. Accordingly, cartridges 300 holding different types of UAVs 200 can be arranged on the cartridge rods 330 in a preferred order based on changing mission requirements for the container 102.

Each of the cartridges 300 can include one or more hangers 304 configured to couple with the cartridge rods 330. The hangers 304 can be configured to enable the cartridges to slide along the at least one cartridge rod. For example, in the illustrated embodiment, each hanger 304 includes rollers 334 configured to roll along a top surface of the cartridge rods 330. However, other implementations of the hangers 304, including both sliding and non-sliding embodiments, are also contemplated. The hangers 304 can be affixed to a hanger base 302, and a cartridge body 306 that at least partially encases the subset 332 of UAVs can be suspended beneath the hanger base 302. Additionally or alternatively, implementations other than cartridge rods 330 or hangers 304 are also contemplated for coupling the cartridges 300 to the container 102. The cartridge body 306 can include side panels 308 connected by stabilizers 310. However, other implementations of the cartridge body 306 are also contemplated.

In some embodiments, at least one cartridge 300 can be configured to dispense any UAV 200 of the subset 332 in any order. For example, if the subset 332 includes fourteen UAVs 200, the cartridge 300 can selectively position any of the fourteen UAVs to be dispensed first. In some such embodiments, the at least one cartridge 300 includes a circulator 322 configured to move the subset 332 along a closed loop path. For example, the circulator 322 can be implemented as a belt that includes engagement connections 324 each configured to engage with one of the UAVs 200. The circulator 322 can be positioned within the cartridge body 306. For example, a mid support 318 can be suspended from the hanger base 302, and a circulator support 320 can be cantilevered from the mid support 318. Other implementations for supporting the circulator 322 are also contemplated. The engagement connections 324 can be configured to engage with the same engagement interfaces 210 of the UAVs 200 that cooperate with the engagement member 118 of the launcher 104. Alternatively, the UAVs 200 can include separate engagement features (not shown) configured to cooperate with the engagement connections 324 of the circulator.

The circulator 322 can be configured to rotate in the closed loop path around the circulator support 320. For example, the at least one cartridge 300 can include a circulator motor 326 configured to drive the circulator 322 around the closed loop path. The circulator motor 326 can be electrically coupled to the container power source 130 via a power circuit path 328 embedded in the circulator support 320 and mid support 318. Other implementations for driving the circulator are also contemplated.

Each of the one or more cartridges 300 can include a gate 312 configured to control the dispensing of the UAVs from the cartridge. In the illustrated embodiment, the gate 312 is configured to move between a retaining position (shown in solid lines in FIG. 3A) to a dispensing position (shown in dashed lines in FIG. 3A). More specifically, the gate 312 in the dispensing position enables the UAV positioned adjacent to the gate to be dispensed from the cartridge 300, and the the gate 312 in the retaining position obstructs the UAV from being dispensed from the cartridge. Other implementations for enabling the dispensing of the UAVs are also contemplated.

As described above, in some embodiments, the controller 110 is in electronic communication with the at least one storage rack 106, which can include the one or more cartridges 300. The controller 110 can be programmed to automatically perform one or more steps such as positioning the UAV handler 108 to receive the UAV 200 from a first cartridge 300, selected from among any of the one or more cartridges 300, and after the step of positioning the UAV handler, operating the first cartridge 300 to dispense the UAV 200. Moreover, the controller can be programmed to automatically determine which cartridge 300 has the correct type of UAV 200 for a particular mission profile. For example, the controller 110 can be programmed to receive a command to launch a specified type of UAV 200 from among the plurality of UAVs 200, and detect that the UAV of the specified type is in the first cartridge. It may be the case in some implementations that more than one cartridge 300 stores the specified type of UAV 200. The controller 110 can further be programmed to detect that two or more UAVs of the specified type are in two or more cartridges 300 including the first cartridge, determine a respective time required for retrieval of each of the two or more UAVs, and then select the first cartridge 300 based on the respective time associated with retrieval of the UAV in the first cartridge 300. For example, the controller 110 can select the cartridge associated with the fastest retrieval time for the specified UAV type. As noted above, in some implementations, the use of the controller 110 to perform one or more of the steps above advantageously increases a speed at which the deployment system 100 can launch multiple UAVs 200.

In some cases, one or more of the UAVs 200 stored in the storage racks 106 may develop a fault during storage in or transportation of the container 102, or otherwise develop some observable indication associated with a potential malfunction of the UAV. The indication may not be detectable until after the UAV is dispensed from the cartridge 300. For example, the primary lift surface 204 may not unfold to the flight configuration. The controller 110 can be programmed to detect, after the UAV is dispensed, that the UAV is defective, and to operate the UAV handler 108 to re-store the UAV in the container 102. In certain embodiments, the UAV handler 108 can be configured to return a dispensed UAV 200 to the at least one storage rack 106 as the re-storage location. For example, the cradle 140 can be vertically actuatable to return a received UAV 200 to the at least one storage rack 106. For example, the re-storage location can be a second cartridge 300 selected from among any of the one or more cartridges 300. The second cartridge 300 can be the cartridge from which the UAV was initially dispensed, or it can be a different cartridge 300 that has space for the defective UAV. Other re-storage locations within the container 102 are also contemplated.

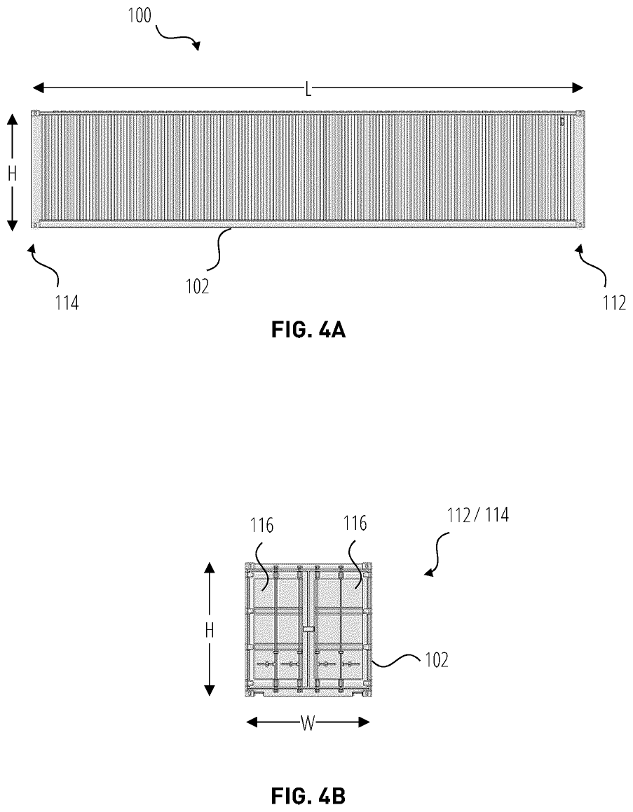

FIG. 4A is a side elevation view, and FIG. 4B is an end elevation view (i.e., an elevation view of the first end 112 or of the second end 114), of an example embodiment of the container 102. In some embodiments, the container 102 has a standard dimensioning of a 20 foot ISO shipping container. For example, the container can have a length L of 20 feet, a width W of 8 feet, and a height H of 9½ feet, sometimes referred to as a High-Cube ISO shipping container. In other embodiments, the container 102 can be dimensioned as a road-haul trailer compliant with a regional standard. For example, the container 102 can have width W of 8½ feet, height H of 8½ feet, and length L of up to 53 feet as implemented on a tractor-trailer in the United States. Standard road-haul trailer dimensions associated with other regions are also contemplated. In other embodiments, the container 102 has length L in the range of 15-53 feet and width W and height H both in the range of 4-10 feet. In some of these embodiments, the container 102 can be additionally configured to meet ISO shipping container certification standards for registration and ease of transportation via railway car, cargo ship, tractor-trailer, or other possible shipping conveyances. In other embodiments, the container 102 may be similarly configured like such a shipping container. For example, the container 102 can be structurally configured to support a weight of one or more additional containers housing deployment systems 100, or other similarly sized shipping containers, to be stacked thereon.

In some embodiments, the container 102 having standard shipping container dimensions and certifications advantageously facilitates transport, storage, and handling of the deployment system 100 using standard shipping conveyances and shipping-port container-handling equipment associated with those standard shipping conveyances. However, embodiments in which the container 102 has non-standard dimensions are also contemplated.

The container 102 can include one or more doors 116 at either or both of first end 112 and second end 114. The doors 116 when closed can create a substantially closed container 102. In this case the term “substantially” closed allows for standard or custom vent or exhaust openings, for example. The one or more doors 116 at the first end 112 can be openable to create an aperture in the container 102 that enables the UAVs 200 to be launched therethrough. In some embodiments, the one or more doors 116 at the first end 112 can be openable to create an aperture that enables at least a portion of the launcher 104 itself to extend therethrough, as described above. Moreover, the doors 116 can be openable to enable the at least one storage rack 106, the UAV handler 108, the launcher 104, and other components of the deployment system 100 to be transferred into and installed in the interior of the container 102.

As described above with respect to the container 102 in general, the doors 116 can standardized in accordance with a standard type of the container 102. In such cases, the cartridges 300 can be sized to facilitate an ease of installation and replacement of the cartridges 300 through the standardized doors 116, which enables the deployment system 100 to be rapidly reconfigured with subsets 332 of UAVs 200 tailored for specific mission requirements. For example, in the illustrated embodiment, each end 112 and 114 includes a pair of doors that substantially cover an area of the respective end when closed, and open outward on vertical hinges to lie flat against an external side wall of the container 102.

Other implementations of the doors 116 are also contemplated.

With reference again to FIG. 1, the deployment system 100 can further include an automated environmental conditioner 136 configured to sense and control a level of at least one environmental parameter within the container 102. For example, the at least one environmental parameter can include one or more of: a temperature, a humidity, a volatile vapor, airborne particulate matter, or another environmental condition. The environmental conditioner 136 can be configured to maintain the level of the at least one environmental parameter within thresholds consistent with nominal operation of the UAVs 200 and the components of the deployment system 100 within the container 102. By way of example, the UAVs 200 can have on-board internal combustion engines that generate heat or exhaust gases after being activated during launch, or payloads that generate heat or fumes when activated, or the power source 130 included in the container 102 can generate such heat, exhaust gases, or fumes. The environmental conditioner 136 can be configured to evacuate from the container 102 exhaust gases or fumes generated therewithin. In some embodiments, the environmental conditioner 136 includes at least one of an active or a passive thermal signature management system configured to control a thermal signature emitted by the container 102. For example, the active or passive thermal signature management system can be operable to mask an infrared emissions profile associated with the UAVs 200 or their payloads. Other implementations of the environmental conditioner 136 are also contemplated.

The controller 110 can be programmed to perform alternative or additional functions. For example, as described above, one or more of the UAVs 200 stored in the storage racks 106 may develop a fault during storage in or transportation of the container 102, or otherwise develop some observable indication associated with a potential malfunction of the UAV. In some cases, the indication may be detectable while the UAV is still stored in the at least one storage rack 106. The controller 110 can be programmed to automatically perform steps including one or more of: initiating a diagnostic test on a selected UAV 200 of the plurality of UAVs, detecting that the selected UAV 200 fails to meet an operational threshold, and, in response to the detecting, storing information indicating that the selected UAV 200 is inoperable. The stored indication can prevent the associated UAV 200 from being selected or dispensed for launch.

To enable the controller 110 to communicate with the UAVs 200 in the at least one storage rack 106 for purposes such as initiating the diagnostic test and retrieving results thereof indicative of whether one or more UAVs 200 meet the operational threshold, the controller can include a wireless transmitter configured for wireless electronic communication with the plurality of UAVs 200 within the container 102. Additionally or alternatively, with reference also to FIG. 3A, the at least one storage rack 106 can include at least one electronics port 314 configured to enable wired electronic communication between the controller 110 and the plurality of UAVs 200 in the at least one storage rack 106. For example, electronics ports 314 can be housed in the cartridge body 306 in locations adjacent to each stored UAV 200 in the cartridge 300. The UAVs 200 can include communication ports 212 (shown in FIG. 2A) configured to cooperate with the electronics ports 314, for example via short-range wireless communication or an extendable physical coupling in the electronics port 314. The electronics ports 314 can be electrically coupled to the controller 110 via an electronics circuit path 316 embedded in the cartridge body 306. Other implementations for communication between the stored UAVs 200 and the controller 110 are also contemplated.

Additionally or alternatively, one or more of the UAVs 200 can include a payload that is in an inactive state, for example during assembly, storage, or transportation of the deployment system 100. The controller 110 can be programmed to send an electronic command to one or more of the UAVs 200 that causes the one or more UAVs 200 to automatically transition the payload from the inactive state to an active state. The controller 110 can be configured to send the command to a UAV 200 prior to dispensing the UAV 200, while the UAV 200 is on the UAV handler 108, or while the UAV 200 is in the engagement position on the launcher 104, for example. The controller 110 can further be programmed to monitor for an acknowledgement of successful payload activation from the UAV 200, and to disapprove the UAV 200 for launch if the acknowledgement is not received within a predetermined response window. In some embodiments, the controller 110 can include a wireless transmitter that is operable to communicate with the UAVs 200 after the UAVs have exited the container 102 (that is, after launch), and the controller 110 can be programmed to send the electronic command to activate the payload after launch of the UAV 200.

As discussed above one or more of the UAVs 200 can include an on-board propulsion system (not shown). Similarly to as described above for activating an on-board payload, the controller 110 can be programmed to send an electronic command to one or more of the UAVs 200 that causes the one or more UAVs 200 to automatically activate the on-board propulsion system. Likewise, one or more of the UAVs 200 can include on-board batteries (not shown), whether as part of the on-board propulsion system or otherwise. The at least one electronics port 314 can be configured for monitoring or charging the on-board batteries, and the controller 110 can be programmed to automatically perform steps including one or more of monitoring a charge level of the on-board batteries, or commanding a charge, discharge, or other conditioning of the on-board batteries.

Additionally or alternatively, the controller 110 can be in communication with the UAVs 200 similarly to as described above, and can be programmed to electronically transfer mission profile data to one or more of the plurality of UAVs 200. For example, when a UAV 200 is selected for launch or after the UAV has exited the container 102, the controller 110 can transfer flight path coordinates, payload settings, or other instructions or updates to an on-board navigation and control system (not shown) of the UAV 200.

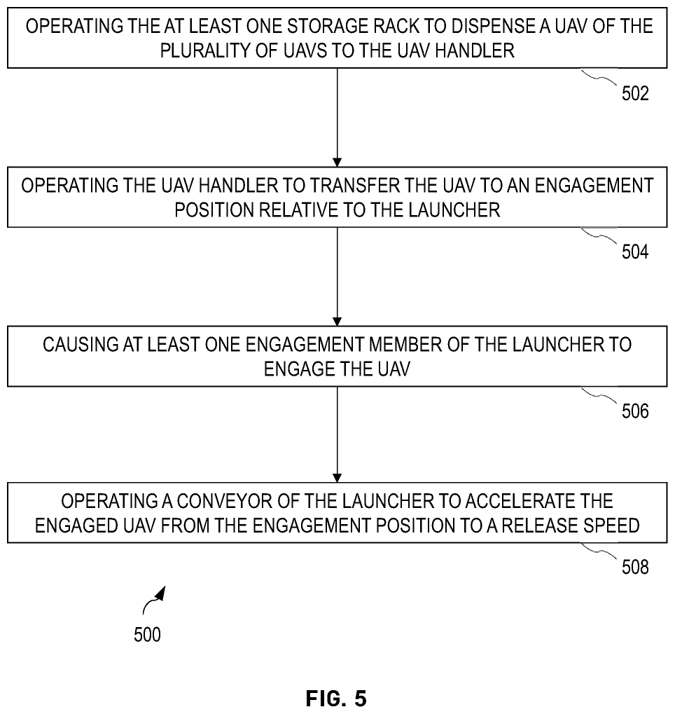

FIG. 5 is a flow diagram of an example embodiment of a method 500 of operating a deployment system, such as the deployment system 100. The deployment system includes a container 102, at least one storage rack 106 disposed within the container and configured to store and dispense a plurality of UAVs 200, a launcher 104, a UAV handler 108, and a controller 110 in electronic communication with the at least one storage rack, the launcher, and the UAV handler. The controller includes at least one processor programmed to automatically perform steps of the method 500, including one or more of: operating the at least one storage rack to dispense a UAV of the plurality of UAVs to the UAV handler (502); operating the UAV handler to transfer the UAV to an engagement position relative to the launcher (504); causing at least one engagement member 118 of the launcher to engage the UAV (506); and operating a conveyor 120 of the launcher to accelerate the engaged UAV from the engagement position to a release speed (508).

The method 500 can include additional or alternative steps, including any steps supported by the descriptions in this disclosure. For example, the launcher further can include an engagement sensor, and the steps can include detecting, based on a signal from the engagement sensor, that the UAV is engaged; and initiating the step of accelerating the UAV to the release speed in response to the detecting.

For example, the conveyor can include a closed loop member, the at least one engagement member can be configured to move with the closed loop member, and the steps can include, after the UAV is accelerated to the release speed, positioning the at least one engagement member to enable engagement of a next UAV of the plurality of UAVs; and operating the conveyor to accelerate the next UAV from the engagement position to the release speed. The steps can also include positioning the UAV handler to receive the next UAV from the at least one storage rack before the step of positioning the at least one engagement member to enable engagement of the next UAV is completed.

For example, each of the UAVs can include a primary lift surface, the at least one storage rack can be configured to store the plurality of UAVs having the primary lift surface in a folded configuration, and the steps can include sending an electronic command to the UAV, wherein the electronic command causes the UAV to automatically transition the primary lift surface from the folded configuration to a flight configuration. Additionally or alternatively, the UAV handler can include an end effector in electronic communication with the controller, and the steps can include operating the end effector to interact with the UAV to transition the primary lift surface from the folded configuration to a flight configuration. The step of operating the end effector to interact with the UAV can include one or more of: decoupling a pin from the UAV; pushing a button or switch on the UAV; or physically bearing against the primary lift surface to move the primary lift surface with respect to a fuselage of the UAV.

For example, the UAV can include a payload in an inactive state, and the steps can include sending an electronic command to the UAV, wherein the electronic command causes the UAV to automatically transition the payload from the inactive state to an active state. Additionally or alternatively, the UAV handler can include an automated end effector in electronic communication with the controller, and the steps can include operating the end effector to interact with the UAV to transition the payload from the inactive state to an active state. The step of operating the end effector to interact with the UAV can include one or more of: decoupling a pin from the UAV; or pushing a button or switch on the UAV.

For example, the container can be configured for mounting on a moving conveyance, and the steps can include receiving conveyance data indicating one or more of a location, a speed, an orientation, or a heading direction of the conveyance; and operating of the launcher based on the received conveyance data. Additionally or alternatively, the steps can include receiving obstruction data indicating a location of obstructions in an environment near the conveyance; and operating the launcher based on the received obstruction data.

For example, the at least one storage rack can include one or more cartridges in electronic communication with the controller, each of the one or more cartridges can be configured to store and dispense a subset of the plurality of UAVs, and the steps can include positioning the UAV handler to receive the UAV from a first cartridge selected from among any of the one or more cartridges; and after the step of positioning the UAV handler, operating the first cartridge to dispense the UAV. The steps can also include receiving a command to launch a specified type of UAV from among the plurality of UAVs; and detecting that the UAV of the specified type is in the first cartridge. Additionally or alternatively, the steps can also include receiving a command to launch a specified type of UAV from among the plurality of UAVs; detecting that two or more UAVs of the specified type are in two or more cartridges including the first cartridge; determining a respective time required for retrieval of each of the two or more UAVs; and selecting the first cartridge based on the respective time associated with the UAV in the first cartridge.

For example, the steps can include detecting, after the UAV is dispensed, that the UAV is defective; and operating the UAV handler and a second cartridge selected from among any of the one or more cartridges to re-store the UAV in the second cartridge.

For example, the steps can include electronically communicating with one or more UAVs of the plurality of UAVs via one or more of a wireless transmitter and a wired electronics circuit path. The steps can also include initiating a diagnostic test on a selected UAV of the plurality of UAVs; detecting that the selected UAV fails to meet an operational threshold; and in response to the detecting, storing information indicating that the selected UAV is inoperable.

For example, one or more UAVs can include an on-board propulsion system, and the steps can include sending an electronic command to the one or more UAVs, wherein the electronic command causes the one or more UAVs to automatically activate the on-board propulsion system.

For example, one or more UAVs can include on-board batteries, the at least one storage rack can include at least one electronics port configured for monitoring or charging the on-board batteries, and the steps can include one or more of: monitoring a charge level of the on-board batteries; or commanding a charge, discharge, or other conditioning of the on-board batteries.

For example, the steps can include electronically transferring mission profile data to one or more UAVs. The step of electronically transferring the mission profile data can be performed while the one or more UAVs are in the at least one storage rack. Additionally or alternatively, the step of electronically transferring the mission profile data can be performed while the one or more UAVs are in the engagement position. Additionally or alternatively, the step of electronically transferring the mission profile data can be performed after the one or more UAVs have exited the container.

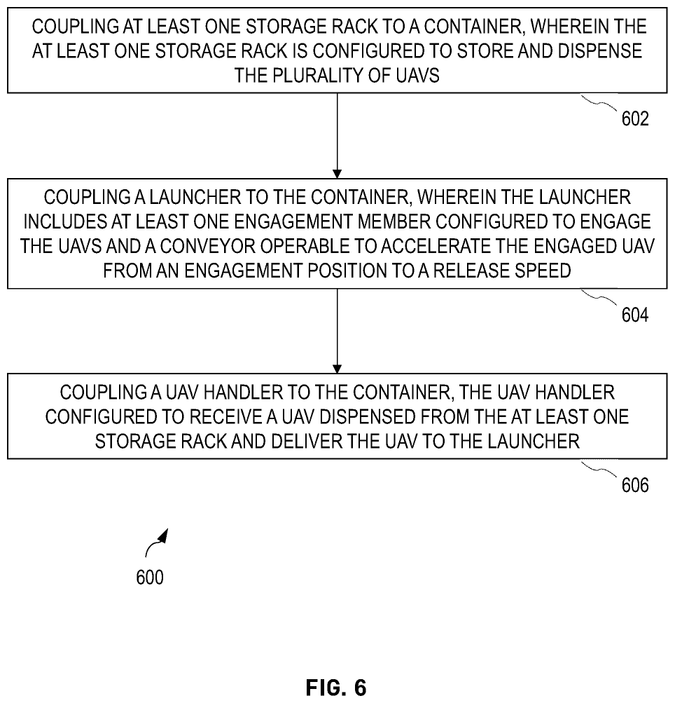

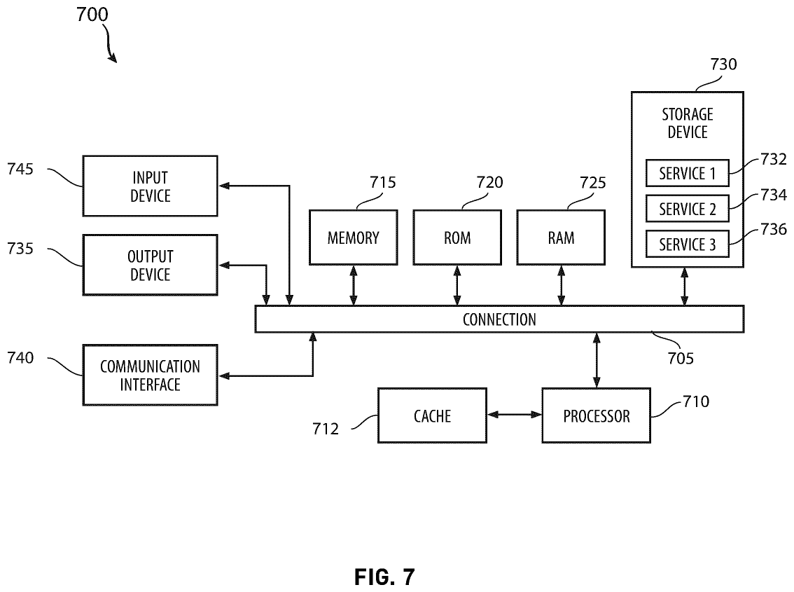

FIG. 6 is a flow diagram of an example embodiment of a method 600 of assembling a deployment system, such as the deployment system 100. The steps of the method 600 can include one or more of: coupling at least one storage rack 106 to a container 102, wherein the at least one storage rack is configured to store and dispense the plurality of UAVs 200 (602); coupling a launcher 104 to the container, wherein the launcher includes at least one engagement member 118 configured to engage the UAVs and a conveyor 120 operable to accelerate the engaged UAV from an engagement position to a release speed (604); and coupling a UAV handler 108 to the container, wherein the UAV handler is configured to receive a UAV dispensed from the at least one storage rack and deliver the UAV to the launcher (606).

The method 500 can include additional or alternative steps, including any steps supported by the descriptions in this disclosure. For example, the steps can include loading the plurality of UAVs into the at least one storage rack before coupling the at least one storage rack to the container. Additionally or alternatively, the steps can include loading the plurality of UAVs into the at least one storage rack after coupling the at least one storage rack to the container.

For example, the steps can include affixing one or more cartridge rods to extend within the container, and the step of coupling the at least one storage rack can include coupling one or more cartridges to the one or more cartridge rods, each cartridge configured to store and dispense a subset of the plurality of UAVs. The step of coupling the one or more cartridges to the one or more cartridge rods can include moving the one or more cartridges through an open door of the container; and sliding the one or more cartridges over the one or more cartridge rods.

For example, the step of coupling the UAV handler to the container can include affixing one or more gantry rails to the container, the gantry rails extending between the at least one storage rack and the launcher; and coupling a cradle for movement along the one or more gantry rails, the cradle configured to receive the UAV dispensed from the at least one storage rack. The step of coupling the cradle for movement along the one or more gantry rails can include coupling one or more transverse rails for movement along the one or more gantry rails; and coupling the cradle for movement along the one or more transverse rails.

For example, the container can include one or more doors at a first end of the container openable to create an aperture, and the step of coupling the launcher to the container can include orienting the conveyor to launch the UAV through the aperture. Additionally or alternatively, the step of coupling the launcher to the container can include coupling a launch platform to the container, the launch platform supporting the conveyor and movable at least partially through the aperture.

For example, the steps of coupling the at least one storage rack, the UAV handler, and the launcher to the container can include coupling the at least one storage rack, the UAV handler, and the launcher to a High-Cube ISO shipping container. Alternatively, the steps of coupling the at least one storage rack, the UAV handler, and the launcher to the container can include coupling the at least one storage rack, the UAV handler, and the launcher to a road-haul trailer compliant with a regional standard.

For example, the steps can include coupling the container to one of a railway car, a cargo ship, or a tractor-trailer.

For example, the steps can include coupling an automated environmental conditioner to the container, the environmental conditioner configured to sense and control a level of at least one environmental parameter within the container, the at least one environmental parameter including one or more of: a temperature, a humidity, a volatile vapor, or airborne particulate matter. The step of coupling the automated environmental conditioner to the container can include coupling at least one of an active or a passive thermal signature management system to the container, the at least one of the active or the passive thermal signature management system configured to control a thermal signature emitted by the container.

For example, the steps can include coupling a controller to the container, the controller configured for electronic communication with and control of the at least one storage rack, the UAV handler, and the launcher. The controller can also be configured for electronic communication with the plurality of UAVs.

FIG. 7 illustrates an example computer device that can be used in connection with any of the systems or components of the controller 110, the environmental conditioner 136, an on-board computing system of the UAV 200, or other components disclosed herein. In this example, FIG. 7 illustrates a computing system 700 including components in electrical communication with each other using a connection 705, such as a bus. System 700 includes a processing unit (CPU or processor) 710 and a system connection 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware or software service, such as service 1-732, service 2-734, and service 3-736 stored in storage device 730, configured to control the processor 710 as well as a special-purpose processor where software instructions are incorporated into the actual processor design. The processor 710 may be a completely self-contained computing system, containing multiple cores or processors, a bus, memory controller, cache, etc. A multi-core processor may be symmetric or asymmetric.

To enable user interaction with the system 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some examples, the input device 745 and output device 735 can be integrated into the local user interface 132 (shown in FIG. 1). In some instances, multimodal systems can enable a user to provide multiple types of input to communicate with the system 700. The communications interface 740 can generally govern and manage the user input and system output, including transceivers that implement remote (for example, wireless) communication. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include services 732, 734, 736 for controlling the processor 710. Other hardware or software modules are contemplated. The storage device 730 can be connected to the system connection 705. In one aspect, a hardware module that performs a particular function can include the software component stored in a computer-readable medium in connection with the necessary hardware components, such as the processor 710, connection 705, output device 735, and so forth, to carry out the function.

In some embodiments, computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Examples of a deployment system for unmanned aerial vehicles are described above in detail. The system is not limited to the specific examples described herein, but rather, components of the system may be used independently and separately from other components and environmental elements described herein.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing [s] shall be interpreted as illustrative and not in a limiting sense.

1-60. (canceled)

61. A method of operating a deployment system, the deployment system including a container, at least one storage rack disposed within the container and configured to store and dispense a plurality of UAVs, a launcher, a UAV handler, and a controller in electronic communication with the at least one storage rack, the launcher, and the UAV handler, the controller including at least one processor programmed to automatically perform steps of the method, the steps comprising:
operating the at least one storage rack to dispense a UAV of the plurality of UAVs to the UAV handler;
operating the UAV handler to transfer the UAV to an engagement position relative to the launcher;
causing at least one engagement member of the launcher to engage the UAV; and
operating a conveyor of the launcher to accelerate the engaged UAV from the engagement position to a release speed.

62. The method of claim 61, wherein the launcher further includes an engagement sensor, and the steps further comprise:
detecting, based on a signal from the engagement sensor, that the UAV is engaged; and
initiating the step of accelerating the UAV to the release speed in response to the detecting.

63. The method of claim 61, wherein the conveyor includes a closed loop member, the at least one engagement member is configured to move with the closed loop member, and the steps further comprise:
after the UAV is accelerated to the release speed, positioning the at least one engagement member to enable engagement of a next UAV of the plurality of UAVs; and
operating the conveyor to accelerate the next UAV from the engagement position to the release speed.

64. The method of claim 63, wherein the steps further comprise:
positioning the UAV handler to receive the next UAV from the at least one storage rack before the step of positioning the at least one engagement member to enable engagement of the next UAV is completed.

65. The method of claim 61, wherein each of the UAVs includes a primary lift surface, the at least one storage rack is configured to store the plurality of UAVs having the primary lift surface in a folded configuration, and the steps further comprise:
sending an electronic command to the UAV, wherein the electronic command causes the UAV to automatically transition the primary lift surface from the folded configuration to a flight configuration.

66. The method of claim 61, wherein each of the plurality of UAVs includes a primary lift surface, the at least one storage rack is configured to store the UAVs having the primary lift surface in a folded configuration, the UAV handler includes an end effector in electronic communication with the controller, and the steps further comprise:
operating the end effector to interact with the UAV to transition the primary lift surface from the folded configuration to a flight configuration.

67. The method of claim 66, wherein the step of operating the end effector to interact with the UAV comprises one or more of:
decoupling a pin from the UAV;
pushing a button or switch on the UAV; or
physically bearing against the primary lift surface to move the primary lift surface with respect to a fuselage of the UAV.

68. The method of claim 61, wherein the UAV includes a payload in an inactive state, and the steps further comprise:
sending an electronic command to the UAV, wherein the electronic command causes the UAV to automatically transition the payload from the inactive state to an active state.

69. The method of claim 61, wherein the UAV includes a payload in an inactive state, the UAV handler includes an automated end effector in electronic communication with the controller, and the steps further comprise:
operating the end effector to interact with the UAV to transition the payload from the inactive state to an active state.

70. The method of claim 69, wherein the step of operating the end effector to interact with the UAV comprises one or more of:
decoupling a pin from the UAV; or
pushing a button or switch on the UAV.

71. The method of claim 61, wherein the container is configured for mounting on a moving conveyance, and wherein the steps further comprise:
receiving at least one of (i) conveyance data indicating one or more of a location, a speed, an orientation, or a heading direction of the conveyance or (ii) obstruction data indicating a location of obstructions in an environment near the conveyance; and
operating the launcher based on the at least one of the received conveyance data and the received obstruction data.

72. (canceled)

73. The method of claim 61, wherein the at least one storage rack includes one or more cartridges in electronic communication with the controller, each of the one or more cartridges is configured to store and dispense a subset of the plurality of UAVs, and the steps further comprise:
positioning the UAV handler to receive the UAV from a first cartridge selected from among any of the one or more cartridges; and
after the step of positioning the UAV handler, operating the first cartridge to dispense the UAV.

74. The method of claim 73, wherein the steps further comprise:
receiving a command to launch a specified type of UAV from among the plurality of UAVs; and
detecting that the UAV of the specified type is in the first cartridge.

75. The method of claim 73, wherein the steps further comprise:
receiving a command to launch a specified type of UAV from among the plurality of UAVs;
detecting that two or more UAVs of the specified type are in two or more cartridges including the first cartridge;
determining a respective time required for retrieval of each of the two or more UAVs; and
selecting the first cartridge based on the respective time associated with the UAV in the first cartridge.

76. The method of claim 73, wherein the steps further comprise:
detecting, after the UAV is dispensed, that the UAV is defective; and
operating the UAV handler and a second cartridge selected from among any of the one or more cartridges to re-store the UAV in the second cartridge.

77. The method of claim 61, wherein the steps further comprise:
electronically communicating with one or more UAVs of the plurality of UAVs via one or more of a wireless transmitter and a wired electronics circuit path.

78. The method of claim 77, wherein the steps further comprise:
initiating a diagnostic test on a selected UAV of the plurality of UAVs;
detecting that the selected UAV fails to meet an operational threshold; and
in response to the detecting, storing information indicating that the selected UAV is inoperable.

79. The method of claim 77, wherein each of the one or more UAVs includes an on-board propulsion system, and the steps further comprise:
sending an electronic command to the one or more UAVs, wherein the electronic command causes the one or more UAVs to automatically activate the on-board propulsion system.

80. The method of claim 77, wherein the one or more UAVs include on-board batteries, the at least one storage rack further includes at least one electronics port configured for monitoring or charging the on-board batteries, and the steps further include one or more of:
monitoring a charge level of the on-board batteries; or
commanding a charge, discharge, or other conditioning of the on-board batteries.

81. The method of claim 77, wherein the steps further comprise:
electronically transferring mission profile data to the one or more UAVs during one or more of:
while the one or more UAVs are in the at least one storage rack;
while the one or more UAVs are in the engagement position; or
after the one or more UAVs have exited the container.

82-100. (canceled)
